(19) United States
(12) Patent Application Publication
(10) Pub. No.: US 2014/0092593 A1
(43) Pub. Date: Apr. 3, 2014

(54) APPARATUS, METHOD, AND SYSTEM FOR REDUCING THE EFFECTIVE PROJECTED AREA (EPA) OF AN ELEVATED LIGHTING FIXTURE WITHOUT THE USE OF AN EXTERNAL VISOR

(71) Applicant: MUSCO CORPORATION, OSKALOOSA, IA (US)

(72) Inventors: Myron Gordin, Oskaloosa, IA (US); Timothy J. Boyle, Oskaloosa, IA (US); Philip D. Hol, New Sharon, IA (US); Luke C. McKee, Oskaloosa, IA (US)

(73) Assignee: MUSCO CORPORATION, OSKALOOSA, IA (US)

(21) Appl. No.: 14/032,579

(22) Filed: Sep. 20, 2013

Related U.S. Application Data
(60) Provisional application No. 61/708,298, filed on Oct. 1, 2012.

(51) Int. Cl. F21K 99/00

(52) U.S. Cl. CPC F21K 9/58
USPC 362/232

(57) ABSTRACT

A design of lighting fixture is presented whereby the outer glass lens—flat in prior art lighting fixtures—is bowed outward. The design of lighting fixture permits a plurality of LED modules to be contained therein, each with their own visor, without constraining the aiming angle of each due to interference between the outer lens and each individual visor. In this manner, an external visor may be omitted thereby obviating undesirable lighting effects such as uneven lighting while still maintaining a reduced effective projected area (EPA) as compared to prior art lighting fixtures with no external visor and a flat outer glass lens.

### CROSS-REFERENCE TO RELATED APPLICATIONS

This application claims priority under 35 U.S.C. §119 to provisional U.S. Application Ser. No. 61/708,298, filed Oct. 1, 2012, hereby incorporated by reference in its entirety.

### BACKGROUND OF THE INVENTION

The present invention generally relates to means of reducing the effective projected area (EPA) of elevated objects. More specifically, the present invention relates to means of reducing the EPA of elevated lighting fixtures in a manner that does not restrict the projection of light therefrom.

As is well known, objects elevated to substantial heights are subject to wind loading. A number of factors determine the load placed on an object exposed to wind; wind speed and the presence of surrounding objects which may disturb air flow are two such factors. Also of great importance to wind loading is the shape of the object itself; the portion of the object directly abutting the air flow path is often referred to as the projected area. For lighting fixtures, the projected area will often change as the aiming angle of the fixture changes.

The projected area, along with the drag coefficient of the object, can be used to calculate the effective projected area (EPA) of the object for a given wind speed at a particular aiming angle. In the lighting industry—particularly outdoor lighting—the weight and EPA of a lighting fixture (as well as associated brackets, crossarms, etc.) must be known so that any elevating structures (i.e., poles) are designed to withstand anticipated wind loading. Guidelines for such may be governed by organizations such as the American Association of State Highway and Transportation Officials (AASHTO).

So it can be seen that there is an interest to keep the weight and EPA of a lighting fixture low; low EPA results in reduced wind loading, reduced wind loading and low weight result in a less substantial elevating structure, and a less substantial elevating structure results in reduced cost. That being said, there are competing interests to consider. For example, a fixture's EPA may be lowest when the fixture includes an external visor or is aimed so to project light downward (i.e., a downlighting application), but aiming a fixture in such a fashion may unduly restrict the spread of light projected therefrom. In such a scenario, a designer may accept a higher EPA by changing the fixture's aiming angle so to project light where it is needed. As another example, it may increase the weight of a lighting fixture to add an external visor, but the added weight may be justified to provide a distinct cutoff and avoid glare. The consequences of choosing one of the aforementioned competing factors over another are compounded when one considers a lighting fixture including a plurality of light sources, such as light-emitting diodes (LEDs). For example, accepting an increase in fixture weight to include an external visor so to provide a distinct cutoff may be sufficient for a large, traditional light source such as a high wattage metal halide lamp, but if the lighting fixture contains a plurality of aimed LEDs, a single exterior visor may no longer provide a clean cutoff and may produce uneven lighting due to the spacing and aiming of the LEDs contained therein.

The art would benefit from additional means of reducing the EPA of lighting fixtures in a manner that does not (i) significantly increase the weight of the fixture and (ii) adversely affect the light projected therefrom, particularly for lighting fixtures comprising a plurality of light sources.

One solution is to omit the external visor of the lighting fixture so to avoid undesirable lighting effects. While this would reduce the weight of the fixture, this would remove any means for providing a distinct cutoff of the light projected therefrom. Further, omitting an external visor can actually increase the EPA of a fixture. One may consider, then, adding a visor to each light source contained within said lighting fixture. While this may address uneven lighting, it does not address EPA and further, adds the concern of how to accommodate both a plurality of light sources and a plurality of individual visors in a compact space while still providing for (i) the aiming of each light source without interference from the other visors both physically and with respect to each source's light output pattern, and (ii) overall heat removal.

Thus, there is room for improvement in the art.

### SUMMARY OF THE INVENTION

A design of lighting fixture is presented whereby the external lens is bowed outward (i.e., domed, convex) so to accommodate a plurality of LED modules at least some of which have their own visors. As envisioned, the design of lighting fixture demonstrates reduced EPA as compared to a standard lighting fixture using a flat outer glass, and comparable EPA and weight as compared to a standard lighting fixture using a flat outer glass with external visor. Further, the envisioned design of lighting fixture has the added benefit of permitting a wide range of aiming angles of the LED modules contained therein without (i) a significant loss in transmission efficiency and (ii) shadowing, uneven light, or other lighting deficiencies common in the art.

It is therefore a principle object, feature, advantage, or aspect of the present invention to improve over the state of the art and/or address problems, issues, or deficiencies in the art.

A method according to at least one aspect of the present invention comprises identifying a lighting application, designing a composite light output pattern (also referred to as a composite beam pattern) so to adequately illuminate the target area of the lighting application, selecting optical elements of and assigning aiming angles to a plurality of LED modules each having at least one LED so to produce the composite light output pattern, and designing and aiming a lighting fixture housing employing a domed lens so to accommodate the plurality of LED modules (i) without dramatically reducing transmission efficiency, (ii) while maintaining a low EPA, and (iii) without causing adverse lighting effects such as shadowing or uneven light.

An apparatus according to at least one aspect of the present invention comprises a lighting fixture for use with the above method generally comprising a lighting fixture housing having an internal mounting surface for one or more of the aforementioned LED modules, one or more optical elements associated with each LED module, a domed outer lens which seals said LED modules in situ in the housing means for maintaining a heat dissipation path from the LEDs of the modules to the exterior of the lighting fixture, and means for adjustably affixing the lighting fixture to a crossarm or other elevating structure.

These and other objects, features, advantages, or aspects of the present invention will become more apparent with reference to the accompanying specification and claims.

### BRIEF DESCRIPTION OF THE DRAWINGS

From time-to-time in this description reference will be taken to the drawings which are identified by figure number and are summarized below.

FIGS. 1A-D illustrate various outer lens and visor arrangements for a lighting fixture affixed to a supporting structure (not illustrated—e.g., pole, tower, super structure, cross arm, etc.) via an adjustable mount. FIG. 1A illustrates a prior art approach using a flat outer lens with no external visor. FIG. 1B illustrates a prior art approach using a flat outer lens with an external visor. FIGS. 1C and D illustrate two possible exemplary embodiments of the present invention utilizing a bowed (i.e., domed or convex) outer lens on the prior art fixture housing of FIGS. 1A and B, and with no external visor.

FIG. 2 illustrates a first specific exemplary embodiment wherein a lighting fixture employs a bowed outer lens on an exemplary fixture housing; in this example, for a downlighting application.

FIG. 3 illustrates an exploded perspective view of the lighting fixture of FIG. 2; the adjustable mount (see, e.g., the mounting knuckle of FIGS. 1C and 1D) and LED modules have been omitted for the sake of clarity.

FIGS. 4A and B illustrate a second specific exemplary embodiment wherein a lighting fixture employs a bowed outer lens on an exemplary fixture housing; in this example, for a floodlighting application. FIG. 4A illustrates the lighting fixture of the second embodiment as it may appear affixed to the bottom of a crossarm or other structure (not illustrated) whereas FIG. 4B illustrates the lighting fixture of the second embodiment as it may appear affixed to the top of a crossarm or other structure (not illustrated).

FIG. 5 illustrates an exploded perspective view of the lighting fixture of FIGS. 4A and B; the adjustable mount and LED modules have been omitted for the sake of clarity.

FIG. 6A illustrates one possible design of LED module for use with the lighting fixture of FIG. 2. FIG. 6A is an exploded perspective view of the entire module.

FIGS. 6B-G illustrate various perspective and isometric views of component 10F of FIG. 6A.

FIGS. 7A and B illustrate one possible design of LED module for use with the lighting fixture of FIGS. 4A and B. FIG. 7A is an exploded perspective of the module 10; FIG. 7B is an enlarged exploded perspective view of the pivot joint 20.

FIG. 8 illustrates one possible method of designing one or more lighting fixtures to suit a lighting application according to aspects of the present invention.

FIGS. 9A-F illustrate multiple views of a thermally conductive wedge for use with the lighting fixtures of FIGS. 2-5.

FIGS. 10A-D illustrate how the aiming of an LED module is affected by the use of the wedge of FIG. 9; in this example, front views of unaffected, shifted right, shifted down, and shifted left modules, respectively.

FIGS. 11A-D are left side elevation views of FIGS. 10A-D, respectively.

FIG. 12 illustrates one possible way in which modules 10 can be positionally affixed within fixture body 300 without physical interference from each other.

FIGS. 13A-C are diagrammatic illustrations of how selection of curvature of the domed lens can reduce light loss.

### DETAILED DESCRIPTION OF EXEMPLARY EMBODIMENTS

### A. Overview

To further an understanding of the present invention, more generalized embodiments followed by more specific exemplary embodiments according to the present invention will be described in detail. Frequent mention will be made in this description to the drawings. Reference numbers will be used to indicate certain parts in the drawings. Unless otherwise indicated, the same reference numbers will be used to indicate the same or similar parts throughout the drawings.

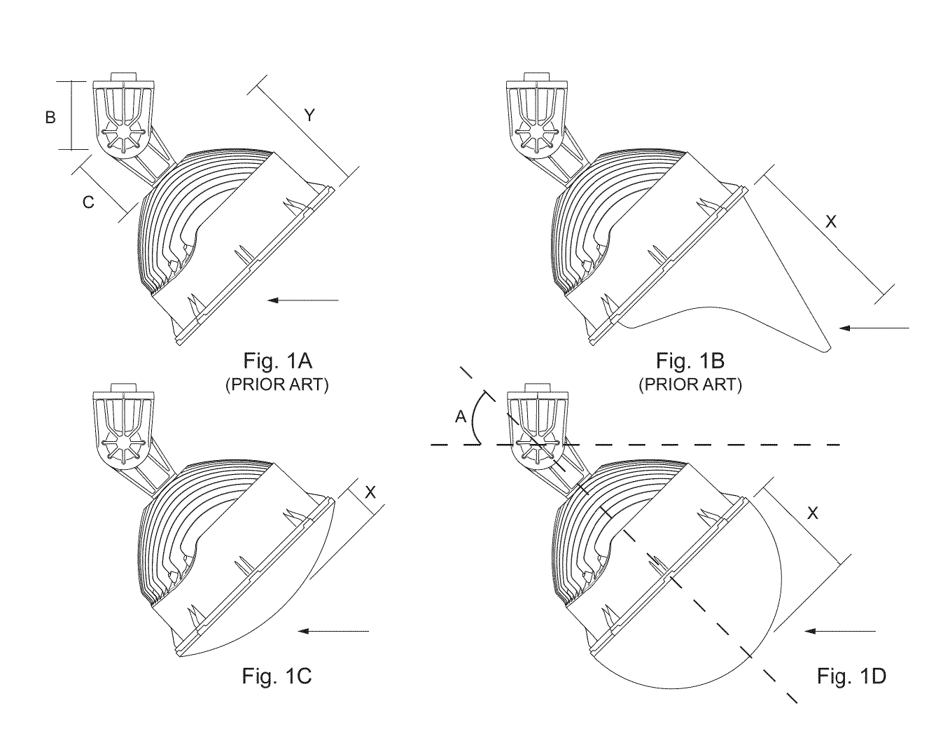

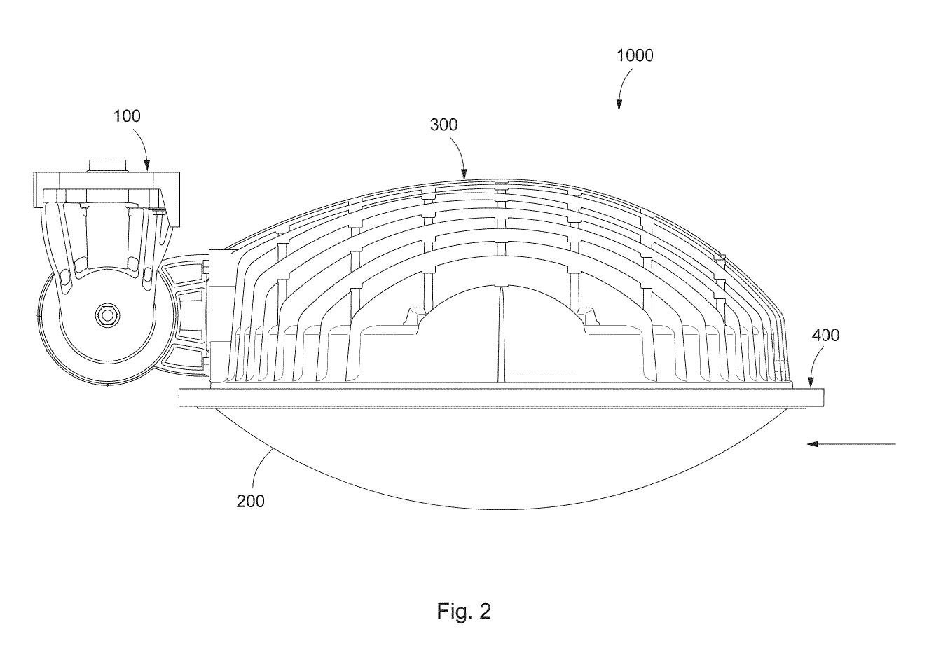

Regarding terminology, use of the term “domed” is simply intended to convey an outer lens that has some perceivable degree of outward curvature. Looking at FIGS. 1A-D, for example, one could state that the lens in FIGS. 1A and B is flat and the lenses in FIGS. 1C and D are domed, even though the curvature of the outer lenses in FIG. 1C and 1D differ. A variety of curvatures of lenses (or even a single lens having different portions with different curvatures) are possible, and envisioned.

An example of a commercially available elevated domed lens fixture can be found in the DECASPHERE™ Luminaire Dome (DCD) available from GE Lighting Solutions, East Cleveland, Ohio, USA. However, such fixtures are traditionally designed for a large, vertically oriented lamp—such as a metal halide (MH) or high pressure sodium (HPS) lamp—and often produce what is referred to as a batwing lighting distribution. Such lighting fixtures are mounted at a relatively low height (e.g., 20 ft) and are designed to be aesthetically pleasing/architecturally interesting, and at such heights do not have to be designed to withstand substantial wind loading or to maintain a low EPA to the same extent as fixtures at substantially higher heights (e.g., around 35 ft for a generic wide-area lighting application to over 100 ft for some sports lighting applications). Further, these known lighting fixtures are typically affixed to a supporting structure (e.g., pole) via a static mount (as opposed to an adjustable armature or mount) and so are effectively limited to downlighting applications, and are not practical for applications such as the aforementioned sports lighting. Such known elevated domed lens fixtures are therefore unsuitable for comparison to the lighting fixtures of the present invention; as such, the following comparisons are made to prior art outdoors sports lighting fixtures. Prior art sports lighting fixtures are mounted much higher (e.g., typically 70 feet or higher), are exposed to significant wind forces, are many times designed for a low EPA, and are typically affixed to a supporting structure via an adjustable armature/mount—also referred to as a mounting knuckle.

Regarding wind loading and EPA, FIGS. 1A-D illustrate a lighting fixture housing with associated mounting knuckle (e.g., as is described in U.S. Patent Publication No. 2011/0149582 incorporated by reference herein), aimed 45° down from horizontal, and upon which a wind load is applied; in this example, directionally indicated by an arrow. The lighting fixture of FIG. 1A includes a flat outer glass lens as is typical of many prior art sports lighting fixtures (e.g., as is described in U.S. Pat. No. 4,423,471 incorporated by reference herein). The lighting fixture of FIG. 1B is similar to that of FIG. 1A but with an external visor. In practice, an external visor could be relatively short with little to no taper inward (e.g., as is described in U.S. Pat. No. 4,816,974 incorporated by reference herein) or relatively long with significant inward taper (e.g., as is described in U.S. Pat. No. 8,162,511 incorporated by reference herein); the former will have a higher EPA with very little glare control whereas the latter can have a lower EPA with significant glare control. For purposes of the present discussion, the external visor of FIG. 1B is considered relatively long (i.e., length X of FIG. 1B is on the order of length Y of FIG. 1A) with a slight taper inward to provide moderate glare control.

In contrast, FIGS. 1C and 1D illustrate two designs of domed outer glass lenses according to the present invention; length X of FIG. 1C is roughly ⅓ that of length Y of FIG. 1A and length X of FIG. 1D is on the order of length Y of FIG. 1A. The shape of the domed lenses in FIGS. 1C and 1D is one of a generally spherical cap or dome in the sense that they both have a generally circular opening—to mate with the generally circular opening of the fixture housing—and a constant radius of curvature from a center of curvature. The lens of FIG. 1D is almost a hemisphere. Of course, this is by way of example and not by way of limitation; for example, a single domed lens could have different areas with different curvatures.

For each fixture illustrated in FIGS. 1A-D, the following factors are held constant in the calculation of EPA: a wind speed of 150 mph along the direction indicated by the arrows in FIGS. 1A-D; a horizontal aiming angle of 0° (i.e., each fixture is head-on to the wind and is not twisted into or out of the plane of the page of FIGS. 1A-D); a vertical aiming angle of 45° (i.e., as measured down from horizontal—see angle A illustrated in FIG. 1D); a fixture housing having a length Y and a generally circular open face having a diameter on the order of 2Y (i.e., twice the length of the fixture housing); and a knuckle centered on the back of the fixture housing, having dimensions B and C roughly ⅓ that of length Y, and having a minimum thickness so not to significantly affect EPA (e.g., on the order of an inch or more). The results from the EPA calculation are shown in Table 1 where Aₚ is projected area, C_{D} is drag coefficient, and EPA is effective projected area.

TABLE 1

| Fixture | Aₚ (in²) | C_{D} | EPA (ft²) |
|---|---|---|---|
| FIG. 1A | 469.0 | 0.95 | 3.11 |
| FIG. 1B | 490.4 | 0.64 | 2.17 |
| FIG. 1C | 469.0 | 0.65 | 2.11 |
| FIG. 1D | 535.3 | 0.52 | 1.94 |

As can be seen from Table 1, EPA is most favorable for the fixture of FIG. 1D; this is perhaps to be expected as the overall fixture of FIG. 1D approximates a sphere, which is known to be one of a few preferred shapes in the art of aerodynamics. That being said, it has already been stated that there are competing interests in designing an elevated lighting fixture—particularly one employing a plurality of light sources. In this example, the decrease in EPA may not be justified by the significant cost and difficulty in manufacturing a bowed outer lens that approximates a hemisphere. This is particularly true because, as envisioned, an outer lens will usually have applied to it an anti-reflective (AR) coating to decrease losses in transmission efficiency. Thus, the following exemplary embodiments utilize the outer lens of FIG. 1C which, for the example of FIG. 1C, creates an overall fixture which approximates a bullet more so than a sphere—a shape somewhat less preferred than a sphere (in terms of reducing drag) but much preferred to a three-dimensional shape having a flat face abutting the direction of air flow (e.g., the overall fixture shape of FIG. 1A). Further examples of preferred shapes considered beneficial in terms of reducing drag can be found at http://www.grc.nasa.gov/WWW/K-12/airplane/shaped.html.

That being said, as will be seen in the exemplary embodiments set forth, the domed lens of FIG. 1C is not simply attached to a generic fixture housing—this may actually increase EPA for some cases—but rather, a fixture housing is selectively designed for a particular lighting application in a manner that (i) accommodates all the necessary optical elements to achieve a desired light output pattern for said lighting application and (ii) cooperates with the lens of FIG. 1C to approximate or even reduce fixture EPA beyond the prior art sports lighting fixtures of FIGS. 1A and B.

### B. Exemplary Method and Apparatus Embodiment 1

A more specific exemplary embodiment, referred to sometimes as Embodiment 1 for convenience only, and also as lighting fixture 1000, utilizing aspects of the generalized example described above, will now be described.

FIG. 2 illustrates a first design of lighting fixture 1000 generally comprising a mounting knuckle 100, a bowed (aka domed, convex) outer lens 200, a fixture body 300, and an intermediate housing body 400. As previously stated, knuckle 100 may be of a design such as that described in U.S. Patent Publication No. 2011/0149582 (or otherwise) and, as envisioned, provides adjustability of fixture 1000 about one or more pivot axes relative to a crossarm or other mounting structure (not illustrated). Given the exemplary wind direction (illustrated directionally by the arrow in FIG. 2), to preserve a low EPA knuckle 100 is mounted to the side of body 300, though other mounting locations are possible and envisioned. Compare, for example, the knuckle mounting of FIG. 2 to the center back of the housing in FIGS. 1C and 1D.

It is to be understood, and is of course known to those skilled in the art, the direction of the wind changes. The arrows and illustrations focus on a wind direction that may put the most substantial wind load on the fixtures for its normal aiming angles. For example, air flow of a direction into the page of FIG. 2 may be disrupted by the presence of other fixtures in an array (not illustrated) and air flow of a direction 180° to the arrow of FIG. 2 (i.e., traveling into the side of fixture body 300 to which armature 100 is mounted) may be disrupted by a cross-arm or supporting structure (not shown), thereby not presenting as substantial a wind load as that in the direction of the arrow of FIG. 2.

Further, a flat surface normal to wind direction presents more wind resistance, and thus more wind load, than if severely tilted relative wind direction. Angle of tilt of a flat surface will increase wind load the closer it comes to normal relative wind direction—this is known. Note that the exterior surface of the fixture of FIG. 2 is predominantly curved in at least one dimension so to present a bowl-type shape approximating an airfoil (i.e., streamlined shape) for the direction of anticipated greatest wind load. It is to be understood that because of changing winds, the variety of orientations of such fixtures when installed, and other components in a lighting system which may impact air flow in a given direction, the invention will have varying effectiveness according to these variables; a particular combination of armature (adjustable or not), domed lens, and fixture housing may be devised to achieve a desired shape/wind resistance for a desired wind load and direction.

In one form, lens 200 is formed from a transparent glass, tempered, with an AR coating, and in accordance with any standards or testing procedures (e.g., ANSI Z97.1) so to make it suitable for a desired lighting application. Fixture body 300 is formed from a suitably thermally conductive material (e.g., aluminum alloy) so to draw heat away from the LEDs affixed thereto, is of a design such that EPA is low regardless of wind direction (though may be lowest in an anticipated wind direction), and contains a plurality of channels to internally route the wiring from said LEDs to knuckle 100 (which further internally routes wires into a crossarm or other elevating structure) so to ensure suitability for outdoor use. Intermediate housing body 400 comprises a plurality of components 400A-E to affix and seal lens 200 to fixture body 300 thereby shielding internal components (e.g., wiring, LEDs) from moisture or other adverse weather conditions.

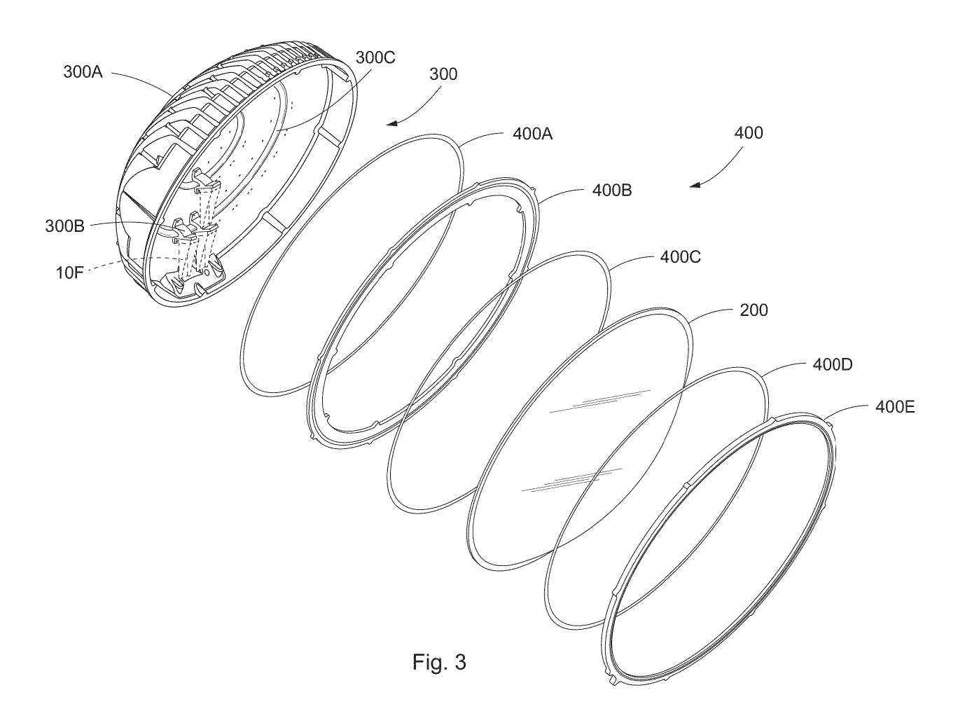

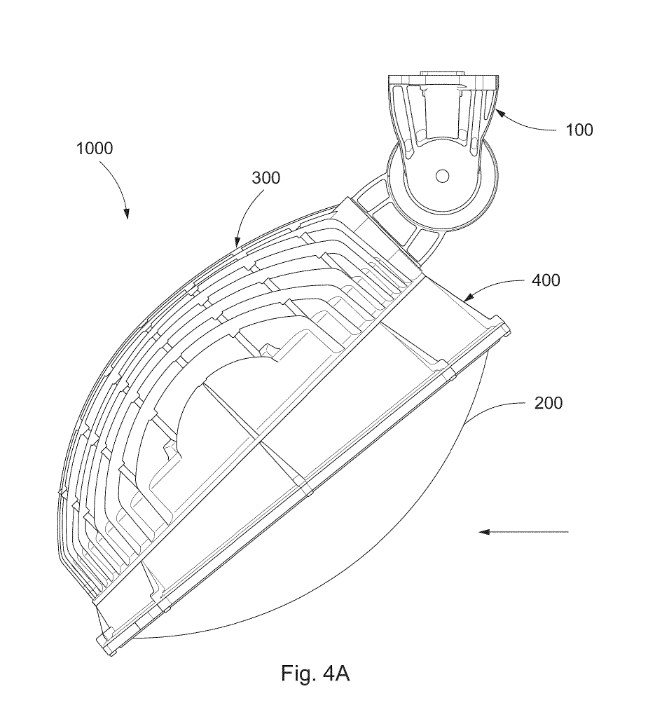

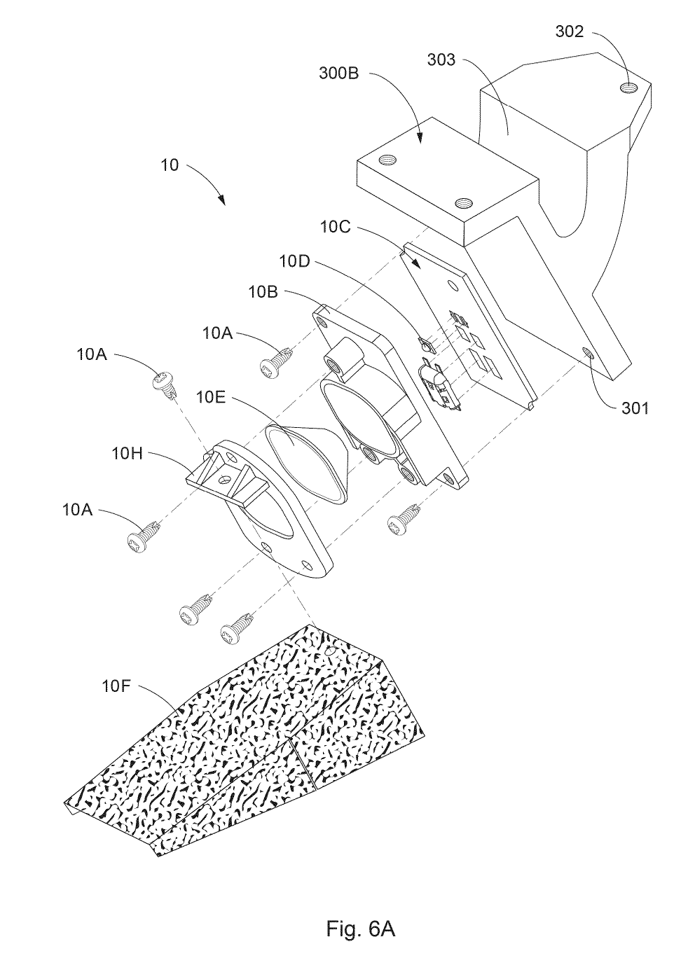

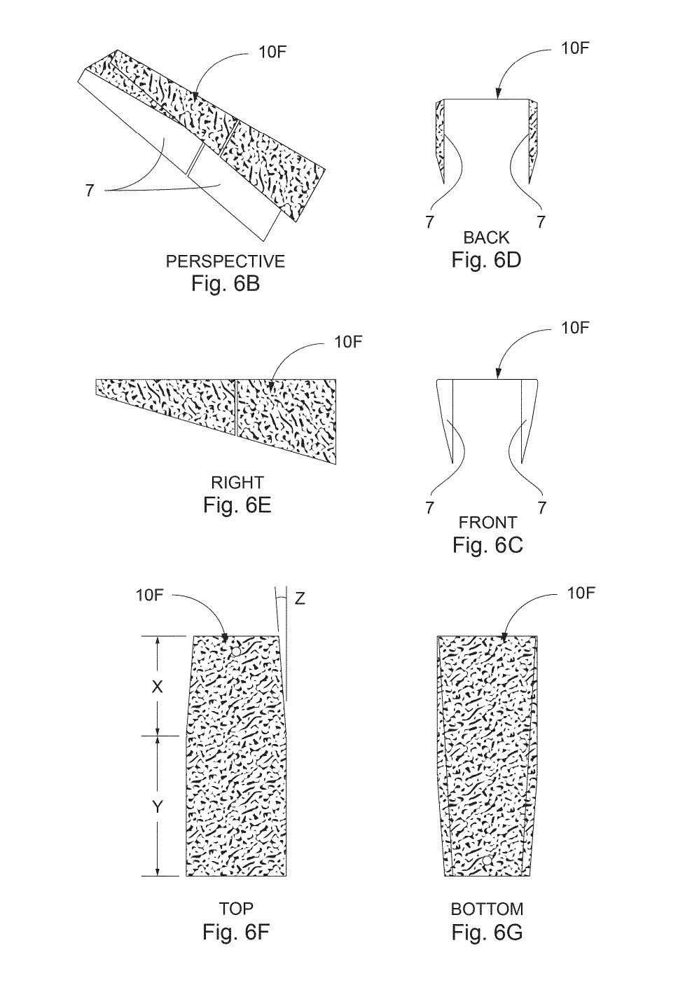

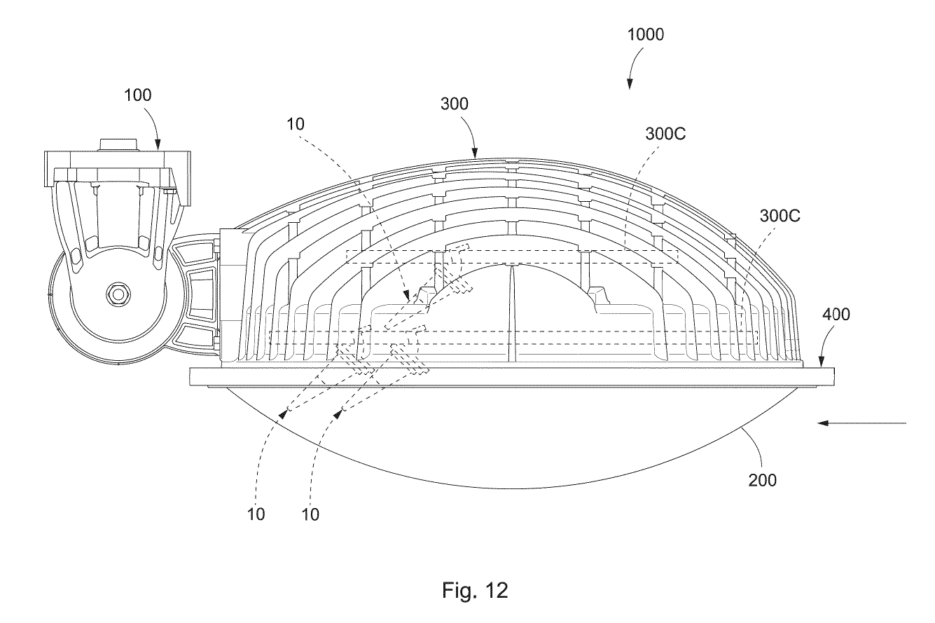

FIG. 3 illustrates fixture 1000 of the present embodiment in greater detail; for the sake of clarity, wiring, LED modules 10, most mounting surfaces 300B, and knuckle 100 have been omitted. As can be seen, fixture body 300 comprises a bowl-shaped housing 300A adapted to accommodate a plurality of aimable and removable mounting surfaces 300B to which LED modules are affixed. In practice, any number of mounting surfaces 300B may be positioned on one of two raised annular sections 300C (also referred to herein as annular rails), rotated either clockwise or counter-clockwise about the center of housing 300A, and secured at a desired position via screws or other fastening devices through threaded apertures 302 (see FIG. 6A) and into complementary holes in housing 300A (see FIG. 3). If desired, commercially available thermal grease or other substance could be applied to surface 303 (FIG. 6A) of mount 300B so to (i) reduce friction and (ii) improve thermal transfer between mounting surface 300B and housing 300A. As envisioned, each mounting surface 300B is machined or otherwise formed such that LEDs mounted thereto are aimed at a specific angle (see also FIG. 6A); for the three mounting surfaces 300B illustrated in FIG. 3, LEDs mounted thereto would be aimed at 30° down from horizontal when fixture 1000 is aimed as in FIG. 2, though this is by way of example and not by way of limitation. Aiming each module in this manner permits each of annular rails 300C to be filled with LED modules 10 of FIG. 6A without having one module's visor 10F physically interfere with another's visor 10F (see ghost lines in FIG. 3). In practice, the spacing of annular raised sections 300C within housing 300A, number and size of modules 10, length of visors 10F, and aiming angle of each module 10 when affixed to mounting surface 300B may be tailored to suit a particular lighting application; if necessary, the curvature of lens 200 can be changed to accommodate the full length of modules 10 when aimed and installed, as the length of one or more visors 10F will likely extend beyond the open face of housing 300A (see FIG. 12) e.g., so to achieve a desired individual beam cutoff. It is assumed that one of average skill in the art of lighting is well aware of how the length and other properties of a visor impact the sharpness (also referred to as distinctiveness or cleanness) of beam cutoff, and so limited discussion is provided herein regarding the theory of such.

FIG. 3 also illustrates in greater detail the components of intermediate housing body 400. As can be seen, intermediate housing body 400 comprises a first sealing member 400A interposing housing 300A and an inner lens rim 400B. A second sealing member 400C interposes inner lens rim 400B and lens 200. A third sealing member 400D interposes lens 200 and an outer lens rim 400E. As envisioned, sealing members 400A, 400C, and 400D create a watertight seal when clamped, screwed, or otherwise affixed to the rim of housing 300A, and are of a material (e.g., silicone) suitable for outdoor use (e.g., operable in a variety of temperatures, resilient to ultraviolet light), though this is by way of example and not by way of limitation. For example, if inner lens rim 400B and outer lens rim 400E are designed in accordance with aspects of the invention described in U.S. Pat. No. 7,527,393—incorporated by reference herein—then a different sealing material might be used as sealing members 400A, 400C, and 400D would no longer be exposed to ultraviolet light from the sun or LEDs.

The LED modules employed in fixture 1000 of the present embodiment may be of a variety of designs; one possible design is illustrated in FIGS. 6A and B. LED module 10 may be affixed directly to mounting surface 300B via screws 10A through visor housing 10H, through lens housing 10B, and into threaded apertures 301 thereby (i) orienting board 10C (by notches at opposite corners) to which one or more LEDs 10D are affixed relative to the target area and (ii) constraining board 10C to and in direct contact with mounting surface 300B to preserve a heat dissipation path by thermal conduction. A lens 10E or other optical element (e.g., diffuser) may be oriented and seated in a complementary receiver in lens housing 10B such that it encapsulates said one or more LEDs 10D and directs light towards the target area. A reflective visor 10F or other optical element (e.g., light absorbing baffle) could be positioned proximate lens 10E (by mounting visor 10F to visor housing 10H via screw 10A) so to redirect at least a portion of the light emitted therefrom. In practice, one could opt to use one or more light directing elements, light redirecting elements, or a combination of light directing and redirecting elements in the design of module 10.

As envisioned and is illustrated in FIGS. 6B-G, all surfaces of visor 10F are reflective with only inner side surfaces 7 (both inner sides along the longitudinal axis of visor 10F) being of a mirror-like finish so to produce specular reflection; all other surfaces are peened, coated, or otherwise textured so to produce diffuse reflection. Further, visor 10F tapers outward (i.e., diverges) from the emitting face of lens 10E at a predetermined angle Z (FIG. 6F) for a predetermined length X before straightening (i.e., neither converging nor diverging) for a predetermined length Y. In practice angle Z, length X, and length Y will vary depending upon the number and model of LEDs in module 10, as well as the dimensions and characteristics of lens 10E; according to one example, Z=7°, X=1.25 in., and Y=1.5 in. for a typical medium beam lens (e.g., beam angle on the order of 20°, though this can vary greatly between manufacturers) encapsulating four model XM-L LEDs (available from Cree, Inc., Durham, N.C., USA) in a 2×2 array. It has been found that the combination of (i) selective diverging angles and lengths, and (ii) selective texture on selective surfaces produces a visor that, when a plurality are employed in fixture 1000, and as compared to standard visors (i.e., where all surfaces are straight and mirror-finish): can reduce striations and produce a smoother light output, constrain the beam pattern in the horizontal direction so to produce a more suitable beam shape for layering/overlapping with one another or with other beam shapes for many applications, and (iii) increase perceived source size thereby reducing glare. It is to be understood, however, that the embodiment is not limited to these specifics.

In practice, fixture 1000 of the present embodiment is best suited for downlighting applications (e.g., parking lot or other similar wide-area lighting). The fixture itself is designed so to present a low EPA regardless of wind direction; see Table 2 below which compares EPA with varying wind direction (vertical aiming angle is 0° and wind speed is 150 mph). The aiming angle of each module 10 is relatively shallow (i.e., the aiming angle down from horizontal is small (e.g., 20° to 30°) thereby producing a composite beam that is wide-spreading, and permitting a significant horizontal distance between poles (or other elevating structures) relative to mounting height.

TABLE 2

| Wind Direction (°) | | | |
|---|---|---|---|
| (0° = direction of | | | |
| arrow in FIG. 2) | Aₚ (in²) | C_{D} | EPA (ft²) |
| 0 | 202.3 | 0.37 | 0.52 |
| 90 | 299.2 | 0.64 | 1.32 |
| 180 | 202.3 | 0.41 | 0.57 |

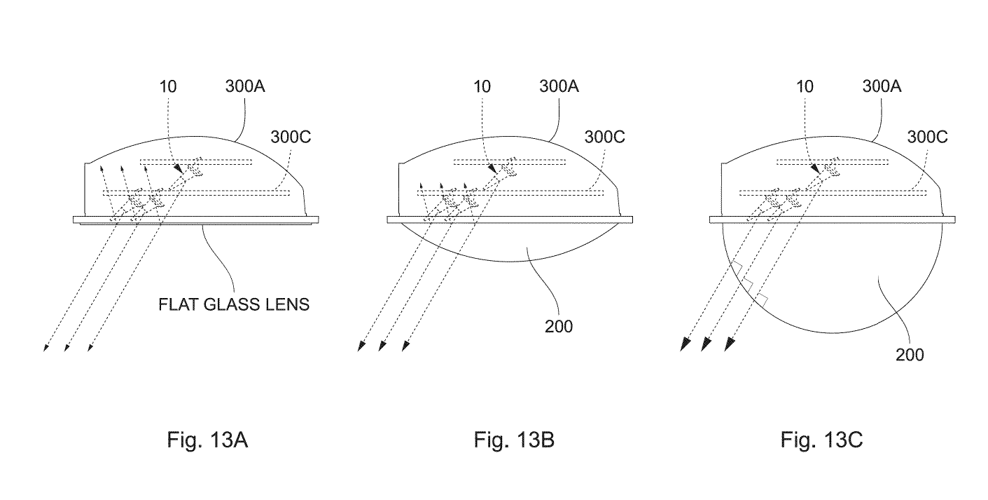

Lastly, the addition of a domed lens permits a long individual visor for any module—because there is more room between the LED and the inner surface of the domed lens than a flat lens (see FIGS. 12 and 13A-C)—thereby providing a more distinct cutoff of individual light output patterns (also referred to as individual beam patterns). Further, the addition of a domed lens preserves transmission efficiency of the modules at their fixed aiming angle; namely, because the curvature of lens 200 can be more closely matched to an aiming angle (i.e., angle/design of mounting surface 300B) so to reduce reflection back into the fixture (i.e., Fresnel reflection/Fresnel loss). As is well known by those skilled in the art, the amount of light emitted from a source that reflects back off a surface (as opposed to transmitting though said surface) increases with the angle of incidence to said light transmission surface. FIGS. 13A-C diagrammatically illustrates how matching domed lens curvature to light module aiming angle can reduce such reflective loss. FIG. 13A shows modules in fixture housing 300A aimed at roughly 30° from horizontal (as in FIG. 2) but with a flat lens. FIG. 13B is the same but with a slightly domed lens. FIG. 13C has a longer curvature domed lens (i.e., a more domed lens), more matched to the 30° aiming angles such that the optical axis from each module is roughly normal to its intersection with the lens 200; it is to be understood that the optical axis for an LED module only generally indicates the vector about which the individual light output pattern is centered, and does not necessary containing the point or area of greatest intensity. FIG. 13A has highest angles of incidence, and therefore more loss in the composite output of the fixture because a proportion of light would reflect off lens 200 and not be useable or effectively control light to the target area; note the small size of arrowheads on the diagrammatic depiction of light transmitting through the lens along the optical axis of the module. FIG. 12C has the lowest angles of incidence; more light would be normal to lens 200 and pass completely through (presumably to the target area). FIG. 13B represents a transmission efficiency somewhere between that of FIGS. 13A and 13C; note that the arrowheads on the diagrammatic depiction of light along the optical axis are larger than in FIGS. 13A, but smaller than FIG. 13C, and that the length of the lines diagrammatically depicting light reflected back into the fixture are shorter for FIG. 13B than FIG. 13A (and completely absent from FIG. 13C). Preliminary testing has found that transmission efficiency is approximately 99% for the exemplary fixture (see FIG. 2) versus 92% with the same configuration but substituting a flat lens, both assuming an AR coating.

If a lighting application is other than downlighting, it is possible to adjust the aiming of fixture 1000 via knuckle 100; however, this will affect the EPA of the fixture. A second embodiment, more suitable for non-downlighting applications (e.g., floodlighting applications), is presently discussed.

### C. Exemplary Method and Apparatus Embodiment 2

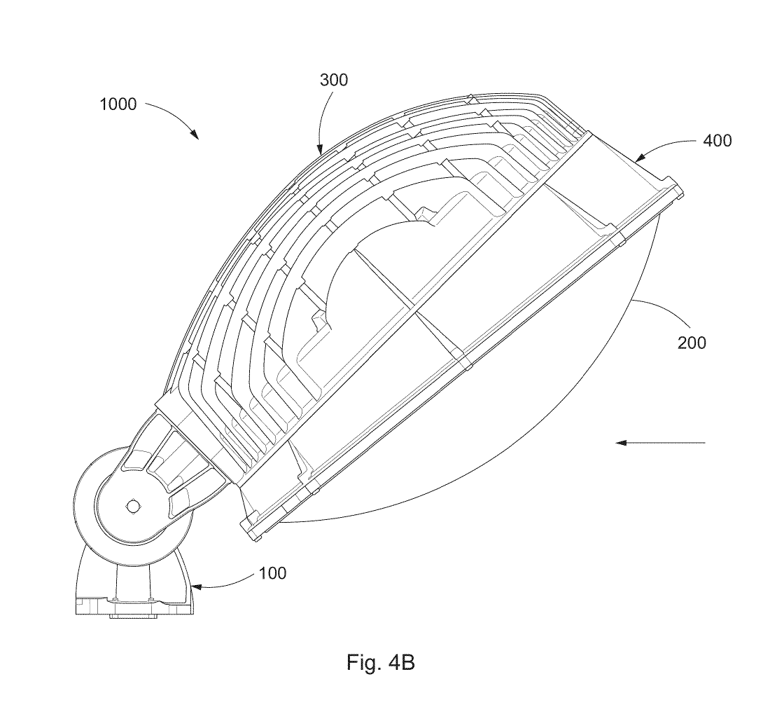

An alternative exemplary embodiment in accordance with at least one aspect of the present invention envisions a fixture 1000 as is illustrated in FIGS. 4A and B. As with the previous embodiment, lighting fixture 1000 of the present embodiment generally comprises a mounting knuckle 100, a bowed (i.e., domed or convex) outer lens 200, a fixture body 300, and an intermediate housing body 400. As previously stated, knuckle 100 may be of a design such as that described in U.S. Patent Publication No. 2011/0149582 (or otherwise) and, as envisioned, provides adjustability of fixture 1000 about one or more pivot axes relative to a crossarm or other mounting structure (not illustrated). A typical vertical aiming angle of 45° is illustrated for the scenario in which a crossarm or other elevating structure (not illustrated) is above fixture 1000 (FIG. 4A) and below fixture 1000 (FIG. 4B), thereby permitting significant flexibility in projecting light all about an elevating structure; of course, a range of horizontal and vertical aiming angles are possible, and envisioned.

As in Embodiment 1, lens 200 can be formed from a transparent glass, tempered, with an AR coating, and in accordance with any standards or testing procedures (e.g., ANSI Z97.1) so to make it suitable for a desired lighting application. Fixture body 300 is formed from a suitably thermally conductive material (e.g., aluminum alloy) so to draw heat away from the LEDs affixed thereto, is of a design such that EPA is low regardless of wind direction relative its outer surfaces, and contains a plurality of channels so to internally route the wiring from said LEDs to knuckle 100 (which further internally routes wires into a crossarm or other elevating structure). Intermediate housing body 400 comprises a plurality of components affix and seal lens 200 to fixture body 300.

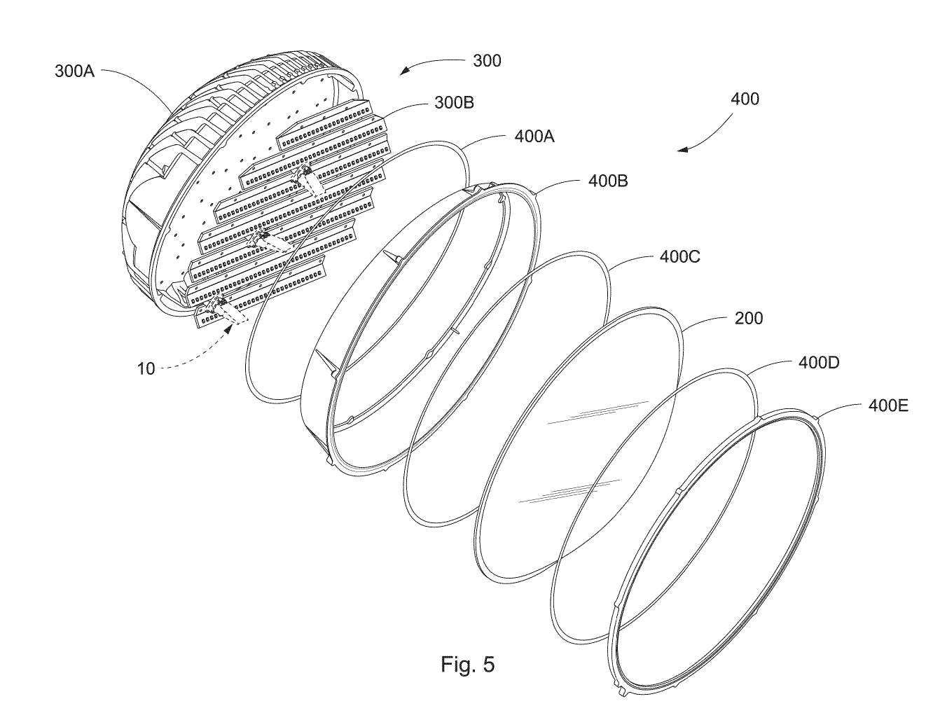

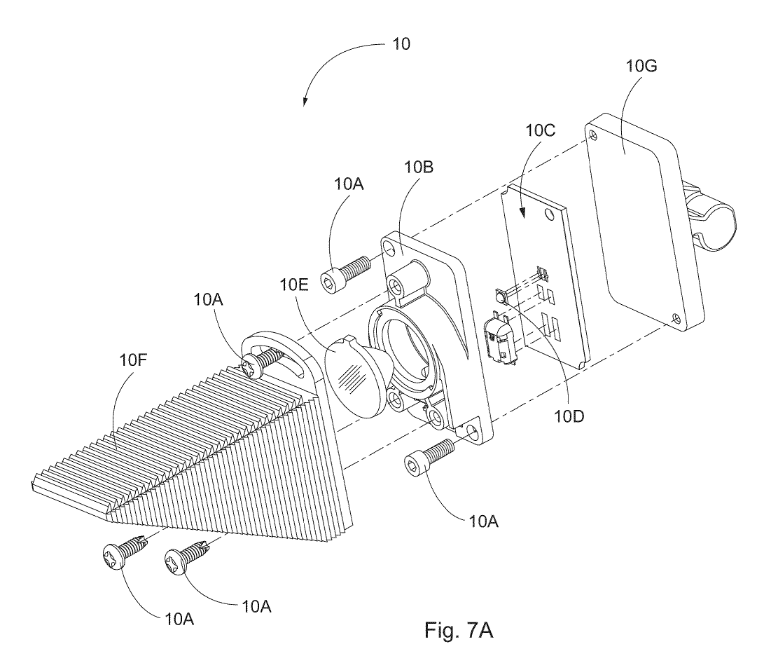

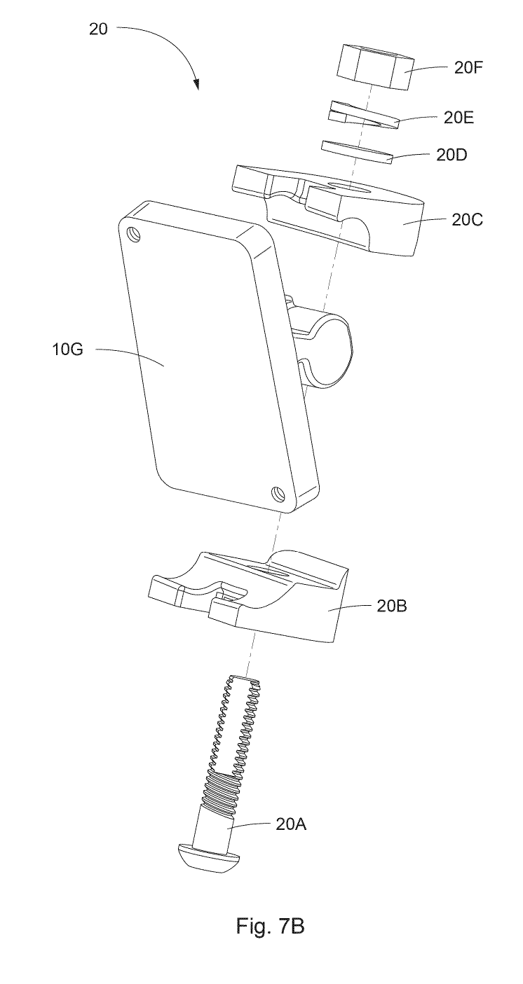

FIG. 5 illustrates fixture 1000 of the present embodiment in greater detail; for the sake of clarity, all wiring, pivot joints 20, and knuckle 100 have been omitted, as well as all but three modules 10 (three are illustrated in ghost lines to demonstrate variable aiming angles). As can be seen, fixture body 300 comprises a housing 300A and a plurality of removable mounting surfaces 300B to which LED modules 10 are affixed. As in the previous embodiment, mounting surfaces 300B of the present embodiment are formed from a suitably thermally conductive material so to preserve the heat dissipation path from LEDs 10D to the exterior of fixture 1000, but unlike the previous embodiment, mounting surfaces 300B of the present embodiment are designed for variable in situ aiming; this is achieved via pivot joint 20 (see FIGS. 7A and B). In practice, screw 20A may be inserted through clamp half 20B, clamp half 20C, a complementary aperture in mounting surface 300B (see rows of apertures along each surface 300B in FIG. 5), and then secured with washers/nuts 20D, 20E, and 20F, thereby constraining LED pivot mount 10G (by clamping to the cylindrical boss on the back side of pivot mount 10G) at a desired—and adjustable—aiming angle. Other mounts with similar capabilities are possible, and envisioned.

FIG. 5 also illustrates in greater detail the components of intermediate housing body 400. As can be seen, intermediate housing body 400 comprises a first sealing member 400A interposing housing 300A and an angled inner lens rim 400B. A second sealing member 400C interposes angled inner lens rim 400B and lens 200. A third sealing member 400D interposes lens 200 and outer lens rim 400E. As envisioned, sealing members 400A, 400C, and 400D create a watertight seal and are of a material (e.g., silicone) suitable for outdoor use (e.g., operable in a variety of temperatures, resilient to ultraviolet light), though this is by way of example and not by way of limitation. For example, if angled inner lens rim 400B and outer lens rim 400E are designed in accordance with aspects of the invention described in incorporated U.S. Pat. No. 7,527,393 then a different sealing material might be used as sealing members 400A, 400C, and 400D would no longer be exposed to ultraviolet light from the sun or LEDs. Components 400A-E and 200 can be held against housing 300A by screws, bolts, clamps, or other methods.

As indicated in FIG. 5, plural modules 10 of FIGS. 7A-B could be individually bolted along each linear mounting rail (i.e., surface 300B); of course, mounting surface 300B of the present embodiment could comprise non-linear mounting rails or some other thermally conductive means of adjustably affixing modules 10 to housing 300A. Each mounting rail of surface 300B can be bolted or screwed or otherwise affixed at generally parallel and spaced apart positions to the interior of housing 300A (see complementary threaded apertures in the interior of FIG. 5). Modules 10 and pivot joints 20 of FIGS. 7A-B along one surface 300B can be staggered relative the surface 300B immediately below to reduce physical and light output interference between modules on different surfaces. But also, the pivot joint 20 allows independent tilting of each module over a range of angles relative to its connection point on a surface 300B. Still further, panning adjustment of each module is possible around the axis of bolt 20A. Thus, at least two degrees of freedom of movement of just pivot joint 20 allows tilt and pan independent adjustment of each light module 10 relative to fixture housing 300A.

The LED modules employed in fixture 1000 of the present embodiment may be of a variety of designs but, as envisioned, are of the design described in U.S. Patent Publication No. 2012/0217897 which is incorporated by reference herein. As can be seen from FIGS. 7A and B—which are reproductions, in part, of FIGS. 1B and 6B, respectively, of U.S. Patent Publication No. 2012/0217897, incorporated by reference herein—LED module 10 comprises one or more LEDs 10D oriented and affixed to said aimed pivot mount 10G via screws 10A through lens housing 10B and into complementary threaded apertures of pivot mount 10G. A lens 10E or other optical element (e.g., diffuser) may be oriented and seated in lens housing 10B such that it encapsulates said one or more LEDs 10D and directs light towards the target area. A reflective visor 10F or other optical element (e.g., light absorbing baffle) could be positioned proximate lens 10E so to redirect at least a portion of the light emitted therefrom. As previously noted, one could opt to use one or more light directing elements, light redirecting elements, or a combination of light directing and redirecting elements in the design of module 10.

In practice, fixture 1000 of the present embodiment is best suited for floodlighting or other variable aiming applications. Removable mounting surface 300B can be designed to accommodate any number of LED modules, the LED modules themselves capable of a wide range of horizontal and vertical aiming angles; an approximate range of 45° and 60°, respectively, for the example of a 3″ spacing between modules with 3″ visors, though this is by way of example and not by way of limitation Inner lens rim 400B is angled so to allow (i) a gradation of aiming angles of the lighting modules contained therein and (ii) an offset between each row of LEDs. This permits one to design a composite light output pattern that is highly customizable yet is not subject to undesirable lighting effects such as shadowing (e.g., where light from one module strikes a portion of another module) or uneven lighting (e.g., where the light projected from one module is blocked by the interior of the fixture and does not reach the target area). The fixture itself (see exterior surfaces of parts 300 and 400) is designed so to present a low EPA regardless of wind direction; see Table 3 below which compares EPA with varying wind direction (vertical aiming angle is 0°, horizontal aiming angle is 45°, and wind speed is 150 mph). Lastly, the addition of a domed lens permits not only a long individual visor for each module (thereby providing a more distinct individual beam cutoff), but also preserves transmission efficiency of the modules at their fixed aiming angle; namely, because the curvature of lens 200 can be matched to an aiming angle (i.e., angle/design of mounting surface 300B and aiming of pivot mount 10G) so to preserve normal or near normal incidence; see again FIGS. 13A-C for a diagrammatic illustration. Preliminary testing has found that transmission efficiency is approximately 99% for the exemplary fixture versus 92% with the same configuration but substituting a flat lens.

TABLE 3

| | Wind Direction (°) | | | |
|---|---|---|---|---|
| | (0° = direction of arrow | | | |
| Fixture | in FIGS. 4A and B) | Aₚ (in²) | C_{D} | EPA (ft²) |
| FIG. 4A | 0 | 454.7 | 0.70 | 2.21 |
| FIG. 4A | 180 | 454.7 | 0.97 | 3.06 |
| FIG. 4B | 0 | 427.3 | 0.68 | 2.03 |
| FIG. 4B | 90 | 354.7 | 0.60 | 1.49 |
| FIG. 4B | 180 | 427.3 | 0.93 | 2.76 |

As can be seen from Table 3, the EPA of fixture 1000 of the present embodiment is higher than that of fixture 1000 of Embodiment 1, but comparable to the prior art fixture of FIG. 1B (see Table 1). As has been stated, there are competing interests in designing an elevated lighting fixture, particularly one employing a plurality of light sources. For some lighting applications it may be preferable to accept a fixture with a slightly higher EPA to gain significant flexibility in directing the light projected therefrom so to create a desired composite light output pattern. Of course, one could adjust the aiming angle of fixture 1000 of Embodiment 2 via knuckle 100 so to minimize EPA, but one may also have to adjust the aiming angle of mounting surfaces 300B and/or the aiming angle of pivot mounts 10G so to preserve the composite light output pattern.

### D. Options and Alternatives

The invention may take many forms and embodiments. The foregoing examples are but a few of those. To give some sense of some options and alternatives, a few examples are given below.

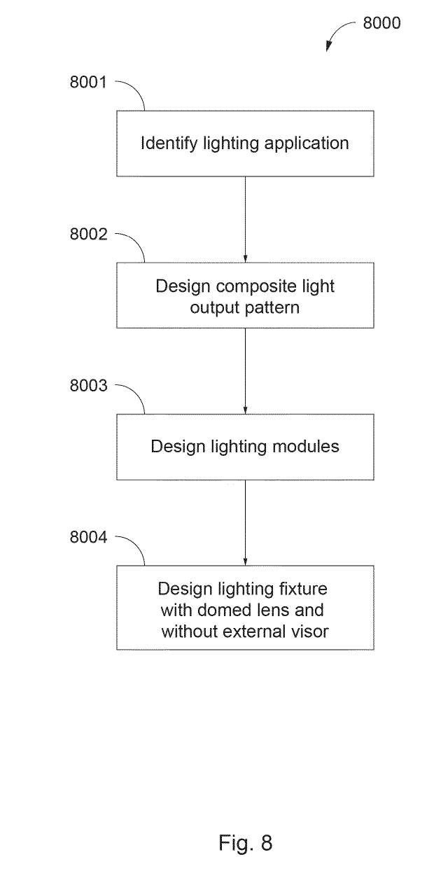

There are a variety of methods by which one may practice aspects according to the present invention; one such method is illustrated in FIG. 8. According to method 8000, a first step 8001 comprises identifying a lighting application (e.g. parking lot or sports field, etc.). Step 8001 may include such things as mapping out the desired target area (in all three dimensions—width, length, height), determining pole characteristics (e.g., size, location, material) based on anticipated wind loading or other ambient conditions (e.g., average temperature, average precipitation or humidity), determining lighting characteristics (e.g., overall light level, max/min ratio of light levels measured between two defined points in the target area), and determining any desired lighting effects (e.g., specified color temperature, remote on/off control, preset dimming levels) which may be related to activities at said target area. The complexity of step 8001 may vary. For example, if the target area is a parking lot, both the overall light level and lighting uniformity may be low with little to no need for lighting effects. Alternatively, if the target area is a professional baseball field, one may need to map out a defined space above the field to be included in the target area (e.g., so to illuminate a ball in flight), meet strict light levels and color rendering to accommodate broadcasting requirements (e.g., as is discussed in U.S. Pat. No. 6,016,389 incorporated by reference herein), or identify means to provide selective on/off/dimming control of one or more subsets of LEDs for a timed theatrical sequence.

A second step 8002 comprises developing a composite light output pattern which adequately illuminates the target area while adhering to the limitations/direction provided by step 8001. Step 8002 may include breaking down the composite beam pattern into one or more individual patterns each of which is associated with a pole location or some other reference point. As an alternative, a lighting designer may fit together a plurality of predetermined individual beam patterns to “build up” the composite beam pattern. Regardless of whether the composite beam is built up or broken down, if desired, each individual pattern may at least partially overlap another pattern so to ensure even lighting—this approach is discussed in greater detail in aforementioned U.S. Patent Publication No. 2012/0217897.

A third step 8003 comprises designing lighting modules 10 so to collectively produce the composite beam pattern developed in step 8002 while adhering to the limitations/direction provided by step 8001. The design options for a single module are practically only limited by ability or desire of the designer; further, there are multiple ways in which a designer can achieve a desired effect. For example, an increased light level can be achieved by adding more LEDs to one or more modules, changing the model of LED used in one or more modules, increasing drive current to existing LEDs, or potentially changing the color of said LEDs thereby increasing perceived brightness (see U.S. Provisional Patent Application Ser. No. 61/738,819 incorporated by reference herein for further details). As another example, an individual beam pattern within the composite beam pattern might be produced from a single module at one pole location, or from two modules in separate fixtures on separate poles. Said beam pattern might be produced from a module employing a single lens, or might be produced from a module employing a combination of reflective visor and diffuser, or might even be produced from a module employing a single visor that is partially reflective but also includes light absorbing baffles. Within practical limits, any number or design of LED modules could be used, with any number of LEDs and/or optical elements per module, with functionality or features of one or more optical elements operating separately or in concert; this may be in accordance with U.S. Patent Publication No. 2013/0077304 or U.S. Patent Publication No. 2012/0307486, both of which are incorporated by reference herein, or otherwise.

A fourth step 8004 comprises designing one or more lighting fixtures so to accommodate the designed lighting modules of step 8003 in a manner that (i) preserves the composite beam pattern developed in step 8002 and (ii) adheres to the limitations/direction provided by step 8001. The complexity of step 8004 can vary depending on previous steps. For example, for a relatively simple downlighting application it may be relatively easy to accommodate a plurality of mounting surfaces with associated modules in a compact space, and may not require an angled lens rim or a significantly bowed or domed (i.e., convex) outer lens. Alternatively, a more demanding floodlighting application may require design of an angled lens rim 400B, a bowed or domed outer lens 200 with areas of different curvature, and a combination of fixed mounting surfaces (300B, Embodiment 1) which provide a more substantial heat sink and variable mounting surfaces (300B/20, Embodiment 2) which are less effective heat sinks—but more versatile—so to balance competing design interests. And, of course, one may need to consider cost, feasibility, and aesthetics when designing a lighting fixture according to step 8004. Aesthetics may dictate a fixture shape that is not preferred in terms of reducing drag, or may dictate a fixture opening that is not circular. In either of these cases, careful design of intermediate housing body 400 or lens 200 may diminish the negative impact of aesthetic choices. Again, it is to be understood that simply affixing a domed lens to any existing fixture housing may not be beneficial in terms of reducing EPA, and even if so, may not provide all the benefits achieved via a methodology that also addresses lighting effects—such as method 800.

A benefit of envisioned fixture 1000—in either embodiment—with respect to step 8004 is such that light redirecting elements (e.g., visor 10F) can be easily switched out without having to completely disassemble a module 10; in Embodiment 1 by simply unfastening screw 10A from the top of visor housing 10H and in Embodiment 2 by simply unfastening screw 10A from visor 10F. Likewise, the beam properties of module 10 can easily be changed by simply rotating or switching out a light directing element (e.g., lens 10E) in lens housing 10B without having to disturb LEDs 10D or visor 10F; this may be useful for providing adjustability via a third axis (e.g., by rotating an elliptical beam lens within lens housing 10B). Still further, if an LED 10D fails or if it is desirable to add or remove LEDs from a module, one may simply switch out boards 10C without affecting the aiming angle or disturbing light redirecting/light directing elements by simply removing screws 10A from lens housing 10B and threaded apertures 301 (in Embodiment 1) or complementary threaded apertures in pivot mount 10G (in Embodiment 2).

There are a number of other alternatives to aspects of the present invention, both in how the invention is practiced and its features. For example, analysis of FIGS. 1A-D yielded an EPA most favorable for FIG. 1D, yet state-of-the-art practices prevent the outer lens of FIG. 1D from being formed in a cost-effective manner. Whether through advancements in glass forming technology (e.g., sagging), simply accepting a higher cost lens, or otherwise, the invention may be practiced using an outer lens such that illustrated in FIG. 1D, or some other design of outwardly bowed (aka domed, convex) lens. As another example, rather than being formed from a transparent glass, lens 200 could be formed from other materials (e.g., polymer) or may be translucent. If so, it is possible lens 200 could be formed in a cost-effective manner even if bowed to a near hemisphere shape as in FIG. 1D. Of course, one must consider the consequences of design choices for lens 200. For example, if forming lens 200 from a polymer, one must consider deformation (e.g., from heat) or degradation (e.g. from ultraviolet light absorption).

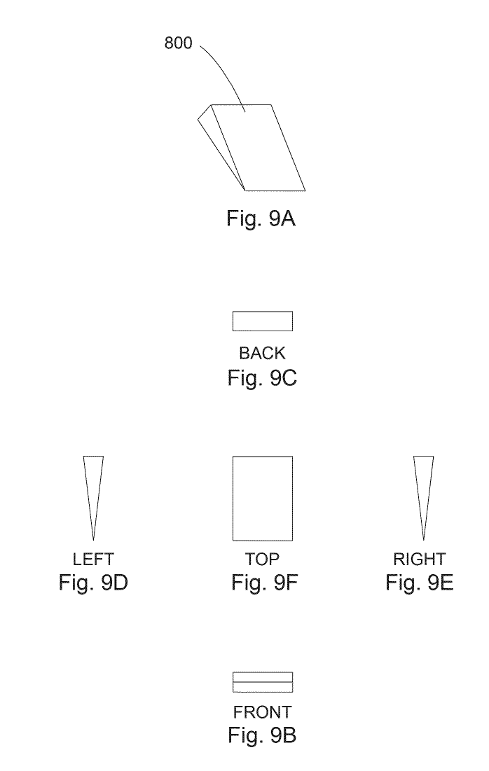

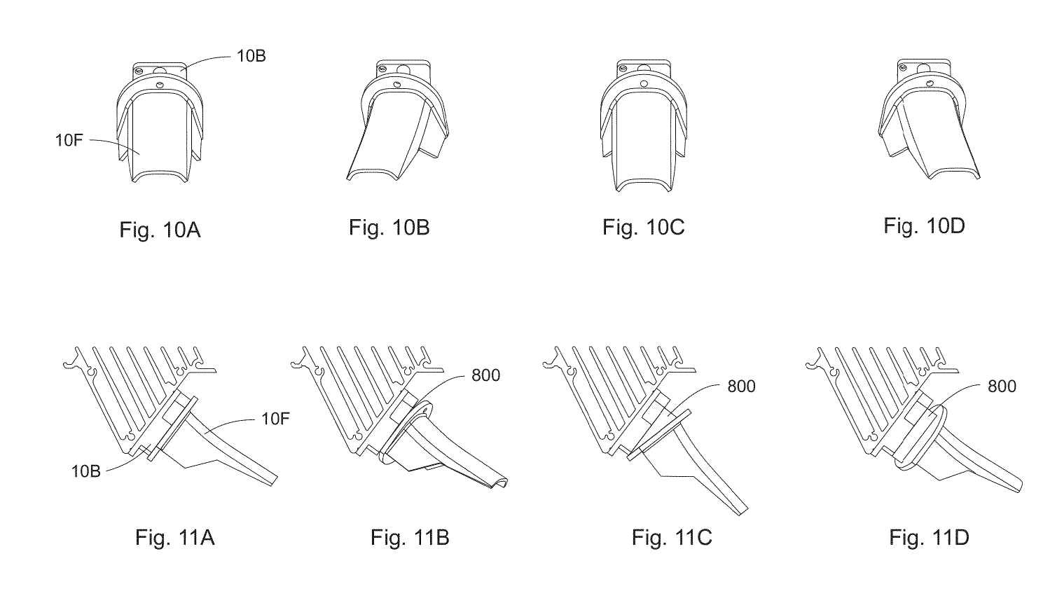

As another example, methods of heat removal may vary from those described herein. For example, annular sections 300C might be excluded in some designs to save on material cost; particularly those in which heat may not be a significant concern. Alternatively, each module 10 may require a substantial heat sink. If so, mounting surfaces 300B (in Embodiment 1) might be integral to housing 300A and include internal channels through which forced air or liquid might flow; this may be in accordance with U.S. patent application Ser. No. 13/791,941 incorporated by reference herein, or otherwise. Internal channels in housing 300A and mounting surface 300B (Embodiment 1) may help to reduce material cost if the designer is willing to accept fixed aiming angles. One way around the fixed angle limitation, while still preserving the heat dissipation path, is to interpose modules 10 and mounting surface 300B (Embodiment 1) with wedges 800 formed from a suitably thermally conductive material (e.g., aluminum alloy). FIGS. 9A-F illustrate wedge 800 in isolation and FIGS. 10A-D and 11A-D illustrate a typical LED module as is (without wedge 800), tilted right approximately 15° using wedge 800, tilted down approximately 15° using wedge 800, and tilted left approximately 15° using wedge 800, respectively; note FIGS. 10A-D and 11A-D are merely intended to illustrate the effect of wedge 800 and do not necessarily reflect the appearance of module 10 of either embodiment.

Lastly, it is to be understood that there are alternative means of coupling parts or providing functionality of one or more parts. For example, as envisioned intermediate housing body 400 comprises a plurality of sealing members and lens rims. Bosses in housing 300A could include threaded bores and bosses around the perimeter of ring 400E could contain through-holes. When the through-holes and threaded bores are aligned, bolts or machine screws could be turned down, clamping all rings 400A-E, as well as lens 200 to housing 300A. Alternatively, a simple clamping mechanism could be used to secure lens 200 to fixture body 300. Any number of sealing members and lens rims could be used and not depart from aspects according to the present invention. Instead of three continuous o-ring sealing members (as is illustrated in FIGS. 3 and 5), the present invention could employ more or fewer sealing members, discontinuous sealing members (e.g., discrete sections of tape), or omit sealing members altogether in favor of a different method of affixing together different portions of fixture 1000 (e.g., welding).

This same approach could be taken with other coupling methods; for example, welding mounting surfaces 300B of Embodiments 1 and 2 to respective housings 300A rather than rely upon fastening devices 10A or other fastening devices such as clamps, glue, or tape. As another example, mounting surface 300B of Embodiment 1 could secured at a desired position in housing 300A relative the target area via spring-loaded clip, with or without annular sections 300C.

What is claimed is:

1. A lighting fixture comprising one or more LED modules made by the process of designing a composite light output pattern so to illuminate a target area comprising:
a. identifying one or more factors associated with illuminating the target area;
b. selecting a number of LED modules for inclusion in the lighting fixture based, at least in part, on the one or more factors associated with illuminating the target area;
c. selecting one or more optical elements for each of the LED modules based, at least in part, on the one or more factors associated with illuminating the target area; and
d. selecting an aiming angle for each of the LED modules based, at least in part, on the one or more factors associated with illuminating the target area;
e. positioning the aimed LED modules in an interior portion of the lighting fixture; and
f. sealing a lens against an open face of the lighting fixture;
g. such that the light projected from each of the LED modules contributes to at least a portion of the composite light output pattern when (i) aimed, (ii) positioned, and (iii) sealed in said lighting fixture.

2. The lighting fixture of claim 1 wherein the one or more optical elements comprises one or more of:
a. a lens;
b. a reflector;
c. a diffuser; or
d. a visor.

3. The lighting fixture of claim 1 wherein step b. further comprises selecting a number and model of LED for inclusion in each LED module.

4. The lighting fixture of claim 1 further comprising an adjustable armature pivotably affixed to the lighting fixture and adapted to orient said fixture relative the target area, and wherein step d. further comprises selecting an aiming angle for each of the LED modules based, at least in part, on the orientation of the lighting fixture relative the target area.

5. The lighting fixture of claim 4 wherein the lighting fixture is subject to wind loading, and wherein the adjustable armature is pivotably affixed to the lighting fixture at a point that does not significantly increase effective projected area (EPA) of the lighting fixture.

6. The lighting fixture of claim 1 further comprising one or more mounting surfaces positioned within the interior portion of the lighting fixture to which the one or more LED modules are affixed.

7. The lighting fixture of claim 6 wherein the aiming angle of each of the LED modules is selected, at least in part, by the position of the one or more mounting surfaces.

8. The lighting fixture of claim 7 wherein a portion of the mounting surfaces are adjustable relative the target area when positioned within the interior portion of the lighting fixture, and wherein the aiming angle of the LED modules affixed to said adjustable mounting surfaces is adjustable after the LED modules are positioned within the lighting fixture.

9. The lighting fixture of claim 1 wherein the lens is convex relative to the open face of the lighting fixture, the curvature of the lens determined, at least in part, by the selected optical elements and selected aiming angle of the one or more LED modules positioned within said lighting fixture.

10. The lighting fixture of claim 9 wherein the lighting fixture is subject to wind loading, and wherein the curvature of the lens is determined, at least in part, by the EPA of the lighting fixture when said lens is sealed against the open face of the lighting fixture.

11. The lighting fixture of claim 2 wherein the visor comprises multiple reflective surfaces, and wherein at least one said surface produces specular reflection and at least one said surface produces diffuse reflection.

12. A method of providing beam pattern control in an elevated, outdoor lighting fixture without (i) increasing effective projected area (EPA) or (ii) including an external visor comprising:
a. providing a lighting fixture housing having an interior space and an opening into said interior space, and comprising:
i. a plurality of light sources;
ii. one or more optical elements associated with one or more light sources wherein each optical element is selected, at least in part, based on a desired beam pattern;
iii. means to adjustably affix each light source at a designated position within the lighting fixture housing and at a designated aiming angle;
b. positioning and aiming the light sources and optical elements within the interior space of the lighting fixture housing such that:
i. the combination of light sources and optical elements produces said desired beam pattern; and
ii. a portion of one or more optical elements extends outwardly from the interior space and beyond opening of the lighting fixture housing;
c. sealing a domed lens having a proximate end and a distal end against the opening of the lighting fixture such that the domed lens encapsulates the positioned and aimed light sources and optical elements without physical interference.

13. The method of claim 12 wherein the lighting fixture housing has a length and wherein the distance between the proximate and distal ends of the domed lens is at least ⅓ the length of the lighting fixture housing.

14. The method of claim 13 wherein the domed lens approximates a hemisphere.

15. The method of claim 12 wherein the domed lens has a first portion having a first curvature and a second portion having a different curvature.

16. The method of claim 12 wherein the domed lens has a curvature designed to decrease effective projected area of the fixture when in an elevated position.

17. The method of claim 12 wherein the domed lens has a curvature designed to improve transmission efficiency or decrease transmission losses of one or more light sources when positioned and aimed within the lighting fixture housing.

18. A wide-area lighting fixture comprising:
a. a bowl-shaped thermally conductive housing comprising,
i. a generally concave interior,
ii. generally convex exterior, and
iii. a generally circular opening to the interior;
b. an armature having a first portion at the housing and a second portion adapted for mounting to an elevating structure, the armature allowing adjustable aiming of the fixture relative to a target area;
c. a removable domed lens comprising,
i. a generally concave interior;
ii. a generally convex exterior; and
iii. a generally circular opening to the interior;
iv. the opening of the domed lens mounted to the opening of the housing such that the interiors of the housing and domed lens defining a collective interior space;
d. a plurality of removable light modules each comprising:
i. a mounting base;
ii. an interchangeable light source mounted to the mounting base and having a light output distribution pattern along an optical axis; and
iii. an interchangeable optical element mounted proximate the light source and adapted to direct or redirect at least a portion of the light output distribution pattern;
iv. each of the plurality of light modules having its mounting base mounted in the housing and its light source, optical element and output axis extending towards the lens;
e. so that:
i. the housing and lens provide generally rounded surfaces for the fixture in all directions for reduced effective projected area relative to a fixture with a flat lens;
ii. light source output axes tend to have less shallow angles of incidence with the lens for improved transmission efficiency relative to a flat lens; and
iii. the collective interior space is increased to allow, if needed, extension of one or more light modules from the interior of the housing into the interior of the lens for light control purposes.

19. The wide-area lighting fixture of claim 18 wherein the light source output axes for at least some of the plurality of light modules extend out of the lens in different directions.

20. The wide-area lighting fixture of claim 18 wherein the mounting base of each light module is thermally conductive so to provide a heat sink from the light source to the housing, and is pivotable in at least one plane when mounted in the housing.
